(19) United States
(12) Patent Application Publication
(10) Pub. No.: US 2004/0071002 A1
(43) Pub. Date: Apr. 15, 2004

(54) Method and apparatus for reducing no-load core loss in inverters

(76) Inventor: Rodger H. Rosenbaum, Seattle, WA (US)

Correspondence Address: Robert M. Storwick, PO Box 386, Mercer Island, WA, 98040, US

(21) Appl. No.: 10/267,277

(22) Filed: Oct. 9, 2002

(51) Int. Cl. H02M 5/42

(52) U.S. Cl. 363/98

(57) ABSTRACT

A method and apparatus, known as an inverter, for converting a source of DC power such as that from batteries, to an alternating voltage similar to what is available from a standard domestic wall plug, but with substantially less power wasted in the inverter itself at low loads, than prior art inverters. At low loads, the inverter produces an output voltage waveform whose average value, as measured by the magnitude of the integral of each half-cycle of the output voltage waveform, is less than the average value of a half-cycle of a sinusoidal voltage waveform having the same period and same extreme voltages as the output voltage waveform.

### TECHNICAL FIELD

The present invention relates to methods and apparatus for inverting DC electrical power to AC electrical power, and more particularly, to methods and apparatus for reducing the no-load power consumption of a DC to AC inverter.

### BACKGROUND OF THE INVENTION

Devices have been available for some decades for converting the direct current (DC) power from energy storage systems, such as a battery, to alternating current (AC) voltages compatible with conventional AC power. These devices are called inverters.

A common type of inverter switches the input DC power at a very high frequency (typically many kHz) to produce an alternating (AC) voltage, and increases the alternating voltage by means of a transformer made of standard silicon steel laminations, rather than a transformer made of ferrite.

A perennial problem with these inverters is that they consume a certain amount of power, known as “tare loss” or “idle power”, from the input DC power source even when they are delivering little or no useful AC power to a load. The tare loss will run down the battery eventually; in fact, at low loads the tare loss is the major component of operating inefficiency in prior art inverters. It is therefore desirable that the tare loss should be as low as possible. The tare loss is composed primarily of two components, copper loss and core loss. This invention provides a method for reducing the core loss.

### SUMMARY OF THE INVENTION

A first aspect of the invention is a technique for reducing the losses in the iron of the transformer core (core loss). When the inverter is very lightly loaded, this tare loss becomes the dominant loss.

Prior art inverters attempt to reduce this tare power by energizing the output of the inverter intermittently with isolated pulses rather than with a continuous sine wave output.

The losses in the iron core are known to be related to the flux density in the core as shown in FIG. 1. According to Faraday's law, the magnetic flux density in the transformer core is proportional to the area (i.e., the magnitude of the integral) of a half cycle of the applied voltage waveform. FIG. 1 shows that the loss in the iron core of the transformer is approximately proportional to the square of the peak flux density.

The intermittent pulse method of the prior art reduces the loss in the iron core of the transformer when the inverter is operating at a low power level by reducing the number of voltage waves applied to the core, as shown in FIG. 8. The present invention reduces core loss by modifying the input voltage waveform to have a reduced area under the voltage waveform while maintaining the peak voltage of the wave. The advantage of the present invention over the intermittent pulse method of the prior art is that, with the present invention, the transformer output wave can be continuous while still having low core loss. A continuous output wave will properly operate small power supplies such as one that operates a VCR's clock, and other similar consumer electronic devices.

According to the first aspect, the invention is a method for reducing tare loss in an inverter within a period of time that includes a plurality of intervals of time. The inverter includes a plurality of switches and a transformer having a primary winding and a secondary winding.

The method includes the step of a), within each interval of time, activating at least one of the switches to apply a first voltage to the primary winding to cause the current in the primary winding to increase, thereby generating a first portion of a voltage waveform in the secondary winding. The voltage waveform has an instantaneous value for each instant in the interval of time, and the first portion of the voltage waveform begins with an initial value of zero volts and ends with an extreme value.

The method also includes the step of b), within each interval of time, activating at least one of the switches to apply a second voltage to the primary winding immediately after the first voltage is applied to the primary winding to cause the current in the primary winding to decrease, thereby generating a second portion of the voltage waveform in the secondary waveform. The voltage waveform begins at the extreme value and ends at zero volts at the end of the interval of time.

Steps a) and b) are performed so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

According to a second aspect, the invention is a method for reducing tare loss in an inverter within a period of time that includes a plurality of intervals of time. The inverter provides electrical power to a load and includes a plurality of switches and a transformer having a primary winding and a secondary winding.

The method includes the steps of a), within each interval of time, determining the power provided to the load by the plurality of switches and b) comparing the power provided to the load to a predetermined threshold. The method also includes the step of c), activating at least one of the switches to apply a first voltage to the primary winding, if the power provided to the load is less than the predetermined threshold, to cause the current in the primary winding to increase, thereby generating a first portion of a voltage waveform in the secondary winding, the voltage waveform having an instantaneous value for each instant in the interval of time, the first portion of the voltage waveform beginning with an initial value of zero volts and ending with an extreme value.

The method further includes the step of d), within each interval of time, activating at least one of the switches to apply a second voltage to the primary winding, if the power provided to the load is less than the predetermined threshold, immediately after the first voltage is applied to the primary winding to cause the current in the primary winding to decrease, thereby generating a second portion of the voltage waveform in the secondary waveform, the voltage waveform beginning at the extreme value and ending at zero volts at the end of the interval of time.

Steps a) and b) are performed so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

According to a third aspect, the invention is an apparatus for reducing tare loss in an inverter within a period of time that includes a plurality of intervals of time. The inverter includes a plurality of switches and a transformer having a primary winding and a secondary winding.

The apparatus includes first means for activating at least one of the switches, within each interval of time, to apply a first voltage to the primary winding to cause the current in the primary winding to increase, thereby generating a first portion of a voltage waveform in the secondary winding, the voltage waveform having an instantaneous value for each instant in the interval of time, the first portion of the voltage waveform beginning with an initial value of zero volts and ending with an extreme value.

The apparatus also includes second means for activating at least one of the switches, within each interval of time, to apply a second voltage to the primary winding immediately after the first voltage is applied to the primary winding to cause the current in the primary winding to decrease, thereby generating a second portion of the voltage waveform in the secondary waveform, the voltage waveform beginning at the extreme value and ending at zero volts at the end of the interval of time.

The first and second means operate so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

According to a fourth aspect, the invention is an apparatus for reducing tare loss in an inverter within a period of time that includes a plurality of intervals of time. The inverter provides electrical power to a load and includes a plurality of switches and a transformer having a primary winding and a secondary winding.

The invention includes first means for determining, within each interval of time, the power provided to the load by the plurality of switches and second means for comparing the power provided to the load to a predetermined threshold.

The invention further includes third means for activating at least one of the switches to apply a first voltage to the primary winding, if the power provided to the load is less than the predetermined threshold, to cause the current in the primary winding to increase. The third means thereby generates a first portion of a voltage waveform in the secondary winding. The voltage waveform has an instantaneous value for each instant in the interval of time, the first portion of the voltage waveform beginning with an initial value of zero volts and ending with an extreme value.

The invention also includes fourth means for activating at least one of the switches to apply a second voltage to the primary winding immediately after the first voltage is applied to the primary winding, if the power provided to the load is less than the predetermined threshold, to cause the current in the primary winding to decrease. The fourth means thereby generates a second portion of the voltage waveform in the secondary waveform, the voltage waveform beginning at the extreme value and ending at zero volts at the end of the interval of time.

The first, second, third and fourth means operate so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

According to a fifth aspect, the invention is an apparatus for reducing tare loss in an inverter within a period of time that includes a plurality of intervals of time. The inverter includes a plurality of switches and a transformer having a primary winding and a secondary winding. The apparatus includes a first electronic circuit to activate at least one of the switches, within each interval of time, to apply a first voltage to the primary winding to cause the current in the primary winding to increase, thereby generating a first portion of a voltage waveform in the secondary winding. The voltage waveform has an instantaneous value for each instant in the interval of time, the first portion of the voltage waveform begins with an initial value of zero volts and ending with an extreme value.

The apparatus also includes a second electronic circuit to activate at least one of the switches, within each interval of time, to apply a second voltage to the primary winding immediately after the first voltage is applied to the primary winding to cause the current in the primary winding to decrease. This circuit generates a second portion of the voltage waveform in the secondary waveform. The voltage waveform begins at the extreme value and ends at zero volts at the end of the interval of time.

The first and second circuits operate so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

According to a sixth aspect, the invention is an apparatus for reducing tare loss in an inverter within a period of time that includes a plurality of intervals of time. The inverter provides electrical power to a load and includes a plurality of switches and a transformer has a primary winding and a secondary winding.

The apparatus includes a first electronic circuit to determine, within each interval of time, the power provided to the load by the plurality of switches and a second electronic circuit to compare the power provided to the load to a predetermined threshold.

The apparatus also includes a third electronic circuit to activate at least one of the switches to apply a first voltage to the primary winding, if the power provided to the load is less than the predetermined threshold, to cause the current in the primary winding to increase. The third electronic circuit thereby generates a first portion of a voltage waveform in the secondary winding. The voltage waveform has an instantaneous value for each instant in the interval of time. The first portion of the voltage waveform begins with an initial value of zero volts and ends with an extreme value.

The apparatus also includes a fourth electronic circuit to activate at least one of the switches to apply a second voltage to the primary winding immediately after the first voltage is applied to the primary winding, if the power provided to the load is less than the predetermined threshold, to cause the current in the primary winding to decrease. The fourth circuit thereby generates a second portion of the voltage waveform in the secondary waveform. The voltage waveform begins at the extreme value and ends at zero volts at the end of the interval of time.

The first, second, third and fourth circuits operate so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

### BRIEF DESCRIPTION OF THE DRAWINGS

FIG. 1 is a plot of iron core loss as a function of the flux density in the iron core.

FIG. 2 is a schematic diagram of a portion of a full bridge inverter known in the prior art and as used by the present invention.

FIG. 3 is a block diagram of a full bridge inverter as used by the present invention.

FIG. 4 is a schematic diagram of a portion of a half bridge inverter known in the prior art and as used by the present invention.

FIG. 5 is a block diagram of a half bridge inverter known in the prior art.

FIG. 6 is a plot of the normal output waveform of a sine wave inverter.

FIG. 7 is a plot of an output waveform produced in accordance with the invention.

FIG. 8 is the output waveform of a prior art inverter operating in its low power mode.

FIG. 9 shows several cycles of the output waveform shown in FIG. 7.

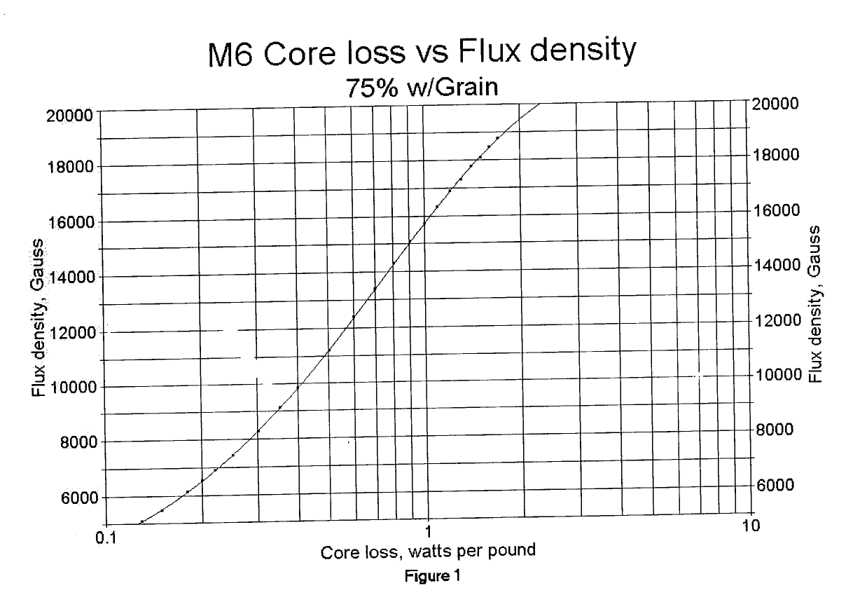

### DETAILED DESCRIPTION OF THE PREFERRED EMBODIMENT OF THE INVENTION

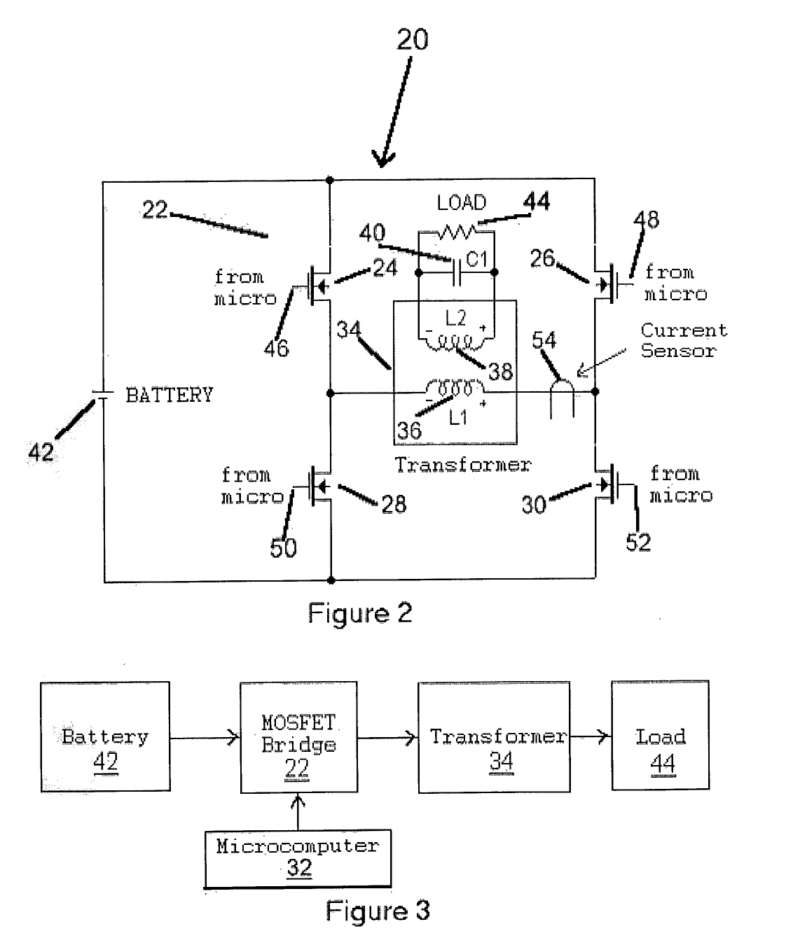

FIG. 2 is a schematic of a generic high-frequency inverter of a sort known in the prior art and as used by the present invention. FIG. 3 is a block diagram of the same inverter. The inverter 20 is of a type known as a “full bridge” inverter. A basic component of the inverter 20 is a MOSFET bridge 22, which includes four MOSFET semiconductor devices 24, 26, 28 and 30. The four MOSFET semiconductor devices 24, 26, 28, and 30 act as controllable switches. Other basic components of the inverter 20 includes a microcomputer 32 for controlling the four MOSFET semiconductor devices 24, 26, 28, and 30; a transformer 34 including of a primary winding 36 and a secondary winding 38; and a capacitor 40. The capacitor 40 is electrically connected in parallel with the secondary winding 38. The inverter 20 is connected to a battery 42, which serves as a DC power source, and to a load 44 (shown as a resistor). The MOSFET semiconductor devices 24, 26, 28, and 30 are respectively controlled by the microcomputer 32 through the lines 46, 48, 50, and 52. A current sensor 54 (such as a transformer) is connected to the microcomputer 32, and is used to detect the output power provided by the inverter.

Inverters having the form of inverter 20 operate by the microcomputer 32 switching the four MOSFET semiconductor devices 24, 26, 28, and 30 in a manner that generates an output AC voltage whose waveform is an approximation to a sine wave. They do so by a method known as “pulse width modulation” (PWM). For PWM, a short time (e.g., 50 microseconds, herein referred to as a clock interval within an interval of time) is selected for operation of the inverter 20. The usual operation of a prior art inverter 20 is for the microcomputer 32 to turn on the MOSFET semiconductor devices 24 and 30 for a subinterval of time of some tens of microseconds while the microcomputer 32 turns the MOSFET semiconductor devices 26 and 28 off. Then the microcomputer 32 turns the MOSFET semiconductor devices 26 and 28 on for the rest of the clock interval while the microcomputer 32 turns the MOSFET semiconductor devices 24 and 30 off. This cycle is repeated over the other clock intervals in the interval of time. This causes the voltage of the battery 40 to be applied first with one polarity direction to the primary winding 36, then with the other polarity.

This described method applies bipolar voltage pulses to the primary winding 36 of the transformer. A second method of inverter operation that has been used more recently is unipolar PWM. A short time (e.g., 50 microseconds, herein referred to as a clock interval within an interval of time) is selected for operation of the inverter 20. For this second method, during a clock interval in a positive half-cycle of the output voltage waveform, the microcomputer 32 turns the MOSFET semiconductor device 26 on and MOSFET device 30 is turned off. The microcomputer 32 then turns the MOSFET semiconductor device 28 on for some tens of microseconds while the microcomputer 32 turns the MOSFET device 24 off. Next, the microcomputer 32 then turns the MOSFET semiconductor device 28 off and turns the MOSFET semiconductor device 24 on for the rest of the clock interval. This cycle is repeated over the other clock intervals during the positive half cycle of the output voltage sinusoidal waveform. The relative timing of the on and off subintervals of the MOSFET semiconductors is controlled by the microcomputer 32 to create a positive half cycle of sinusoidal voltage at the output of the inverter. For this second method, during a clock interval in a negative half-cycle, MOSFET semiconductor device 30 is turned on and MOSFET semiconductor device 26 is turned off by the microcomputer 32. MOSFET semiconductor device 24 is now turned on for some tens of microseconds while MOSFET semiconductor device 28 is turned off by the microcomputer 32; then MOSFET semiconductor device 28 is turned on and MOSFET device 24 is turned off by the microcomputer 32 for the rest of the clock interval. This cycle is repeated over the other clock intervals during the negative half cycle of the output sinusoid. The relative timing of the on and off subintervals of the MOSFET semiconductors is controlled to create a negative half cycle of sinusoidal voltage at the output of the inverter. Bipolar PWM will be assumed for the rest of this document, but unipolar PWM would behave similarly.

The capacitor 40 averages the voltage pulses seen at the secondary winding 38, thereby suppressing the high-frequency components of the voltage that would otherwise be present. The ratio of the first polarity applied voltage on-time to the second polarity applied voltage on-time (i.e., the subinterval to the remainder of the interval) determines the average output voltage seen at the secondary winding 38 of the transformer 34.

The ratio of the on-time for the first voltage to the on-time for the second voltage is caused to vary with time, in order to approximate a mathematical sine function. For example, at the zero-crossings of the output voltage, the first and second voltages are turned on for equal subintervals of time (i.e., the subinterval equals half of the interval), whereas, at the extremities of the output voltage, one of the two polarity voltages is turned on for a maximum subinterval of time while the other of the two polarity voltages is turned on for a minimum subinterval of time. The on-time ratio typically varies periodically with a frequency of 60 Hertz (i.e., the period of time is 1/60 second) thus creating the desired low-frequency voltage approximation to a sine wave on the load 42 at the secondary winding 30 of the transformer 34.

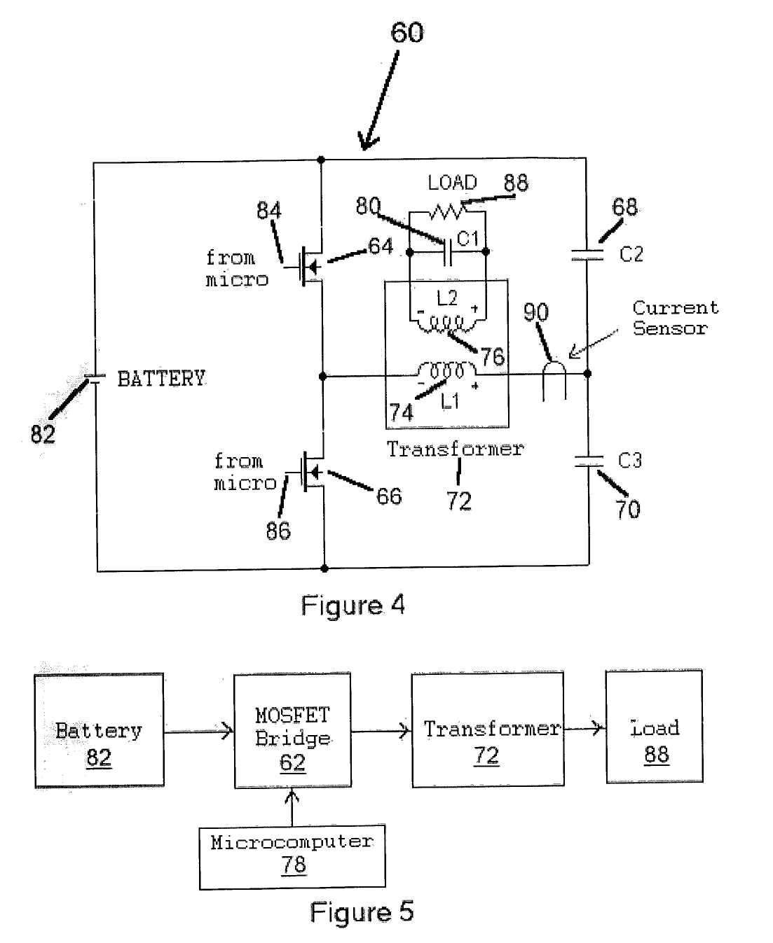

FIG. 4 is a schematic diagram of an alternative embodiment of the present invention, known as a “half bridge” inverter, and FIG. 5 is a block diagram of the half bridge inverter known in the prior art. A basic component of the inverter 60 is a MOSFET half bridge 62 which includes two MOSFET semiconductor devices 64 and 66 and capacitors 68 and 70. The two MOSFET semiconductor devices 64 and 66 act as controllable switches.

Other basic components of the inverter 60 include a microcomputer 78 (shown in FIG. 5) for controlling the two MOSFET semiconductor devices 64 and 66; a transformer 72 including a primary winding 74 and a secondary winding 76, and a capacitor 80. The capacitor 80 is electrically connected in parallel with the secondary winding 76. The inverter 60 is connected to a battery 82, which serves as a DC power source, and to a load 88 (shown as a resistor). The microcomputer 78, through the lines 84 and 86, controls the MOSFET semiconductor devices 64 and 66, respectively.

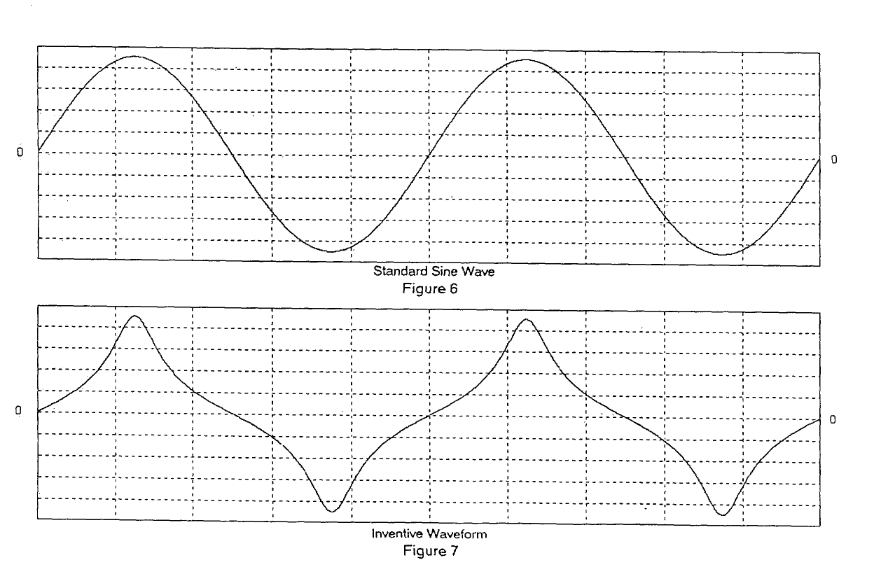

A reduction in no-load losses, which are primarily core loss, can be obtained by modifying the output waveform as shown in FIGS. 6 and 7. FIG. 6 shows the normal output at high power; this is a standard sine wave output as provided by prior art inverters as described above. FIG. 7 is a plot of the output waveform for a very lightly loaded inverter in accordance with the invention. The output waveform is modified by the operation of the microcomputer 78. When the microcomputer 78 detects that the inverter 20 is very lightly loaded (by means of the current transformer 54 shown in FIG. 2), the microcomputer 78 changes the output waveform to that shown in FIG. 7. It can easily be seen that the area under a half cycle of the waveform in FIG. 7 is much less than under a half cycle of the waveform in FIG. 6. This results in substantially less iron loss, since the loss in the iron core of a transformer varies as approximately the square of the area under a half-wave of the applied voltage.

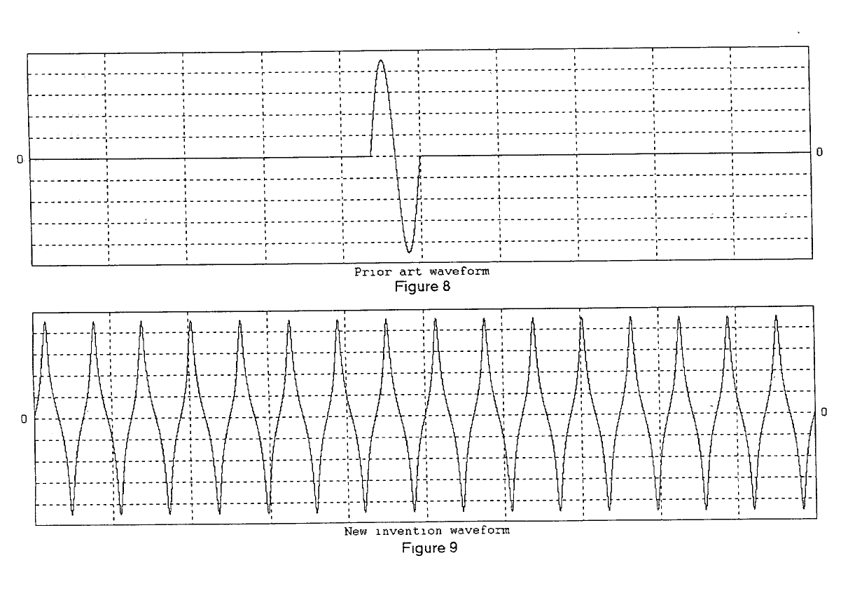

For comparison, FIG. 8 is a plot of the output waveform for an inverter known in the prior art when very lightly loaded and using the intermittent pulse method to reduce tare loss. This prior art method simply generates a single cycle of a sine wave about once a second, which reduces the core loss, but cannot properly operate small power supplies such as those that run the clock display in a VCR. The waveform of the new invention is not intermittent; it is continuous as shown in FIG. 9, but with less area under each half wave than the full sine wave of FIG. 6. But since the peak output voltage remains the same as that of the unmodified waveform of FIG. 6, it can properly operate small power supplies, such as used to operate clock displays in consumer electronics because the performance of such devices depends on the peak voltage of the applied waveform.

The inverter just described consists of a transformer made of silicon steel laminations, driven with PWM high frequency pulses to approximate a full sine wave at high power levels, and approximating the inventive waveform at very light loads. Other embodiments of DC to AC inverters might also use the inventive waveform to reduce tare loss, and would be within the scope of the present invention.

The waveform shown in FIG. 7 is not the only possible waveform possessing the desirable low-loss quality. Various waveforms intermediate between the two shown in FIGS. 6 and 7 can be produced by programming the microcomputer 32 (78) to adjust the on and off times of the MOSFET semiconductor devices 24, 26, 28 and 30 (or 64 and 66) appropriately. This will cause a first portion of the output voltage waveform to change from zero volts to an extreme (maximum or minimum) voltage that is equal to the extreme voltage of the standard sine wave shown in FIG. 6. It will then cause a second portion of the output voltage waveform to change from the extreme voltage to zero volts, so that the magnitude of the integral of the output voltage waveform is less than the integral of a half-cycle of a sine wave having the same extreme values and having a duration equal to the combined duration of the first and second portions of the output voltage waveform.

While the output voltage waveform can take any form satisfying the conditions above, it is preferable that the first portion of the output voltage waveform changes monotonically from zero volts to the extreme voltage and that the second portion of the output voltage waveform changes monotonically from the extreme voltage to zero volts. It is also preferable, but not necessary, that the output voltage waveform be periodic. It is further possible that, at every point in time, the deviation of the output voltage waveform differs from zero volts by a voltage that is less than the voltage of the sine wave at the same point in time.

While the foregoing is a detailed description of the preferred embodiment of the invention, there are many alternative embodiments of the invention that would occur to those skilled in the art and which are within the scope of the present invention. Accordingly, the present invention is to be determined by the following claims.

1. A method for reducing tare loss in an inverter within a period of time that includes a plurality of intervals of time, the inverter including a plurality of switches and a transformer having a primary winding and a secondary winding, the method comprising the steps of:
a) within each interval of time, activating at least one of the switches to apply a first voltage to the primary winding to cause the current in the primary winding to increase, thereby generating a first portion of a voltage waveform in the secondary winding, the voltage waveform having an instantaneous value for each instant in the interval of time, the first portion of the voltage waveform beginning with an initial value of zero volts and ending with an extreme value; and
b) within each interval of time, activating at least one of the switches to apply a second voltage to the primary winding immediately after the first voltage is applied to the primary winding to cause the current in the primary winding to decrease, thereby generating a second portion of the voltage waveform in the secondary waveform, the voltage waveform beginning at the extreme value and ending at zero volts at the end of the interval of time,
so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

2. The method of claim 1, wherein at least one of the first and second portions of the voltage waveform varies monotonically.

3. The method of claim 2, wherein the first portion of the voltage waveform varies monotonically from zero volts to the extreme value.

4. The method of claim 2, wherein the second portion of the voltage waveform varies monotonically from the extreme value to zero volts.

5. The method of claim 1, wherein at each instant of time in each interval of time, the magnitude of the instantaneous value of the waveform does not exceed the magnitude of the corresponding instantaneous value of the half-cycle of the sine wave.

6. The method of claim 1, wherein the plurality of switches forms a full bridge connected to a source of DC electrical power.

7. The method of claim 1, wherein the plurality of switches forms a half bridge connected to a source of DC electrical power.

8. The method of claim 1, wherein the switches are MOSFETs.

9. The method of claim 1, wherein the voltage waveform is a periodic waveform.

10. The method of claim 1, wherein steps a) and b) are performed by a microprocessor.

11. A method for reducing tare loss in an inverter within a period of time that includes a plurality of intervals of time, the inverter providing electrical power to a load and including a plurality of switches and a transformer having a primary winding and a secondary winding, the method comprising the steps of:
a) within each interval of time, determining the power provided to the load by the plurality of switches;
b) comparing the power provided to the load to a predetermined threshold;
c) if the power provided to the load is less than the predetermined threshold,
c1) activating at least one of the switches to apply a first voltage to the primary winding to cause the current in the primary winding to increase, thereby generating a first portion of a voltage waveform in the secondary winding, the voltage waveform having an instantaneous value for each instant in the interval of time, the first portion of the voltage waveform beginning with an initial value of zero volts and ending with an extreme value; and
c2) within each interval of time, activating at least one of the switches to apply a second voltage to the primary winding immediately after the first voltage is applied to the primary winding to cause the current in the primary winding to decrease, thereby generating a second portion of the voltage waveform in the secondary waveform, the voltage waveform beginning at the extreme value and ending at zero volts at the end of the interval of time,
so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

12. The method of claim 11, wherein at least one of the first and second portions of the voltage waveform varies monotonically.

13. The method of claim 12, wherein the first portion of the voltage waveform varies monotonically from zero volts to the extreme value.

14. The method of claim 12, wherein the second portion of the voltage waveform varies monotonically from the extreme value to zero volts.

15. The method of claim 11, wherein at each instant of time in each interval of time, the magnitude of the instantaneous value of the waveform does not exceed the magnitude of the corresponding instantaneous value of the half-cycle of the sine wave.

16. The method of claim 11, wherein the plurality of switches forms a full bridge connected to a source of DC electrical power.

17. The method of claim 11, wherein the plurality of switches forms a half bridge connected to a source of DC electrical power.

18. The method of claim 11, wherein the switches are MOSFETs.

19. The method of claim 11, wherein the voltage waveform is a periodic waveform.

20. The method of claim 11, wherein steps c1) and c2) are performed by a microprocessor.

21. The method of claim 20, wherein steps a) and b) are performed by a microprocessor.

22. An apparatus for reducing tare loss in an inverter within a period of time that includes a plurality of intervals of time, the inverter including a plurality of switches and a transformer having a primary winding and a secondary winding, comprising:
first means for activating at least one of the switches, within each interval of time, to apply a first voltage to the primary winding to cause the current in the primary winding to increase, thereby generating a first portion of a voltage waveform in the secondary winding, the voltage waveform having an instantaneous value for each instant in the interval of time, the first portion of the voltage waveform beginning with an initial value of zero volts and ending with an extreme value; and
second means for activating at least one of the switches, within each interval of time, to apply a second voltage to the primary winding immediately after the first voltage is applied to the primary winding to cause the current in the primary winding to decrease, thereby generating a second portion of the voltage waveform in the secondary waveform, the voltage waveform beginning at the extreme value and ending at zero volts at the end of the interval of time,
so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

23. The apparatus of claim 22, wherein at least one of the first and second portions of the voltage waveform varies monotonically.

24. The apparatus of claim 23, wherein the first portion of the voltage waveform varies monotonically from zero volts to the extreme value.

25. The apparatus of claim 23, wherein the second portion of the voltage waveform varies monotonically from the extreme value to zero volts.

26. The apparatus of claim 22, wherein at each instant of time in each interval of time, the magnitude of the instantaneous value of the waveform does not exceed the magnitude of the corresponding instantaneous value of the half-cycle of the sine wave.

27. The apparatus of claim 22, wherein the plurality of switches forms a full bridge connected to a source of DC electrical power.

28. The apparatus of claim 22, wherein the plurality of switches form a half bridge connected to a source of DC electrical power.

29. The apparatus of claim 22, wherein the switches are MOSFETs.

30. The apparatus of claim 22, wherein the voltage waveform is a periodic waveform.

31. The apparatus of claim 22, wherein the first and second means for activating at least one of the switches are a programmed microprocessor.

32. An apparatus for reducing tare loss in an inverter within a period of time that includes a plurality of intervals of time, the inverter providing electrical power to a load and including a plurality of switches and a transformer having a primary winding and a secondary winding, comprising:
first means for determining, within each interval of time, the power provided to the load by the plurality of switches;
second means for comparing the power provided to the load to a predetermined threshold;
third means for activating at least one of the switches to apply a first voltage to the primary winding, if the power provided to the load is less than the predetermined threshold, to cause the current in the primary winding to increase, thereby generating a first portion of a voltage waveform in the secondary winding, the voltage waveform having an instantaneous value for each instant in the interval of time, the first portion of the voltage waveform beginning with an initial value of zero volts and ending with an extreme value; and
fourth means for activating at least one of the switches to apply a second voltage to the primary winding immediately after the first voltage is applied to the primary winding, if the power provided to the load is less than the predetermined threshold, to cause the current in the primary winding to decrease, thereby generating a second portion of the voltage waveform in the secondary waveform, the voltage waveform beginning at the extreme value and ending at zero volts at the end of the interval of time,
so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

33. The apparatus of claim 32, wherein at least one of the first and second portions of the voltage waveform varies monotonically.

34. The apparatus of claim 33, wherein the first portion of the voltage waveform varies monotonically from zero volts to the extreme value.

35. The apparatus of claim 33, wherein the second portion of the voltage waveform varies monotonically from the extreme value to zero volts.

36. The apparatus of claim 32, wherein at each instant of time in each interval of time, the magnitude of the instantaneous value of the waveform does not exceed the magnitude of the corresponding instantaneous value of the half-cycle of the sine wave.

37. The apparatus of claim 32, wherein the plurality of switches form a full bridge connected to a source of DC electrical power.

38. The apparatus of claim 32, wherein the plurality of switches form a half bridge connected to a source of DC electrical power.

39. The apparatus of claim 32, wherein the switches are MOSFETs.

40. The apparatus of claim 32, wherein the voltage waveform is a periodic waveform.

41. The apparatus of claim 32, wherein the third and fourth means are a programmed microprocessor.

42. The apparatus of claim 41, wherein the first, second, third, and fourth means are a programmed microprocessor.

43. An apparatus for reducing tare loss in an inverter within a period of time that includes a plurality of intervals of time, the inverter including a plurality of switches and a transformer having a primary winding and a secondary winding, comprising:
a first electronic circuit to activate at least one of the switches, within each interval of time, to apply a first voltage to the primary winding to cause the current in the primary winding to increase, thereby generating a first portion of a voltage waveform in the secondary winding, the voltage waveform having an instantaneous value for each instant in the interval of time, the first portion of the voltage waveform beginning with an initial value of zero volts and ending with an extreme value; and
a second electronic circuit to activate at least one of the switches, within each interval of time, to apply a second voltage to the primary winding immediately after the first voltage is applied to the primary winding to cause the current in the primary winding to decrease, thereby generating a second portion of the voltage waveform in the secondary waveform, the voltage waveform beginning at the extreme value and ending at zero volts at the end of the interval of time,
so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

44. The apparatus of claim 43, wherein at least one of the first and second portions of the voltage waveform varies monotonically.

45. The apparatus of claim 44, wherein the first portion of the voltage waveform varies monotonically from zero volts to the extreme value.

46. The apparatus of claim 44, wherein the second portion of the voltage waveform varies monotonically from the extreme value to zero volts.

47. The apparatus of claim 43, wherein at each instant of time in each interval of time, the magnitude of the instantaneous value of the waveform does not exceed the magnitude of the corresponding instantaneous value of the half-cycle of the sine wave.

48. The apparatus of claim 43, wherein the plurality of switches forms a full bridge connected to a source of DC electrical power.

49. The apparatus of claim 43, wherein the plurality of switches form a half bridge connected to a source of DC electrical power.

50. The apparatus of claim 43, wherein the switches are MOSFETs.

51. The apparatus of claim 43, wherein the voltage waveform is a periodic waveform.

52. The apparatus of claim 43, wherein the first and second electronic circuits include a programmed microprocessor.

53. An apparatus for reducing tare loss in an inverter within a period of time that includes a plurality of intervals of time, the inverter providing electrical power to a load and including a plurality of switches and a transformer having a primary winding and a secondary winding, comprising:
a first electronic circuit to determine, within each interval of time, the power provided to the load by the plurality of switches;
a second electronic circuit to compare the power provided to the load to a predetermined threshold;
a third electronic circuit to activate at least one of the switches to apply a first voltage to the primary winding, if the power provided to the load is less than the predetermined threshold, to cause the current in the primary winding to increase, thereby generating a first portion of a voltage waveform in the secondary winding, the voltage waveform having an instantaneous value for each instant in the interval of time, the first portion of the voltage waveform beginning with an initial value of zero volts and ending with an extreme value; and
a fourth electronic circuit to activate at least one of the switches to apply a second voltage to the primary winding immediately after the first voltage is applied to the primary winding, if the power provided to the load is less than the predetermined threshold, to cause the current in the primary winding to decrease, thereby generating a second portion of the voltage waveform in the secondary waveform, the voltage waveform beginning at the extreme value and ending at zero volts at the end of the interval of time,
so that the magnitude of the integral of the voltage waveform is less than the magnitude of the integral of a half-cycle of a sine wave that begins at the beginning of the interval of time, ends at the end of the interval of time, and has an extreme value that equals the extreme value of the voltage waveform at the mid-point of the interval of time.

54. The apparatus of claim 53, wherein at least one of the first and second portions of the voltage waveform varies monotonically.

55. The apparatus of claim 54, wherein the first portion of the voltage waveform varies monotonically from zero volts to the extreme value.

56. The apparatus of claim 54, wherein the second portion of the voltage waveform varies monotonically from the extreme value to zero volts.

57. The apparatus of claim 53, wherein at each instant of time in each interval of time, the magnitude of the instantaneous value of the waveform does not exceed the magnitude of the corresponding instantaneous value of the half-cycle of the sine wave.

58. The apparatus of claim 53, wherein the plurality of switches form a full bridge connected to a source of DC electrical power.

59. The apparatus of claim 53, wherein the plurality of switches form a half bridge connected to a source of DC electrical power.

60. The apparatus of claim 53, wherein the switches are MOSFETs.

61. The apparatus of claim 53, wherein the voltage waveform is a periodic waveform.

62. The apparatus of claim 53, wherein the third and fourth electronic circuits include a programmed microprocessor.

63. The apparatus of claim 53, wherein the first, second, third and fourth electronic circuit include a programmed microprocessor.
